(19) United States
(12) Patent Application Publication
(10) Pub. No.: US 2026/0038195 A1
(43) Pub. Date: Feb. 5, 2026

(54) INTERACTIVE SELFIE PANORAMA CAPTURE AND MULTI-PERSPECTIVE UNDISTORTED SELFIE GENERATION

(71) Applicant: Samsung Electronics Co., Ltd., Suwon-si (KR)

(72) Inventors: Soumendu Majee, McKinney, TX (US); Gunawath Dilshan Godaliyadda, Allen, TX (US); John Seokjun Lee, Allen, TX (US); Hamid Rahim Sheikh, Allen, TX (US); Michael O. Polley, Garland, TX (US)

(21) Appl. No.: 19/251,588

(22) Filed: Jun. 26, 2025

Related U.S. Application Data
(60) Provisional application No. 63/677,031, filed on Jul. 30, 2024.
(60) Provisional application No. 63/753,791, filed on Feb. 4, 2025.

(51) Int. Cl. G06T 15/20; G06T 7/55; G06V 10/764; H04N 23/60; H04N 23/61; H04N 23/63; H04N 23/667; H04N 23/698

(52) U.S. Cl. CPC G06T 15/205; G06T 7/55; H04N 23/61; H04N 23/632; H04N 23/64; H04N 23/667; H04N 23/698; G06T 2207/20081; G06T 2207/20092; G06V 10/764

(57) ABSTRACT

An electronic device includes at least one imaging sensor configured to obtain an input set of images of a scene. The electronic device also includes at least one processing device configured to generate a differentiable 3D model of the scene based on an iterative process using the input set of images and project the differentiable 3D model into an image space to generate an estimated burst of selfie images. To obtain the input set of images, the at least one processing device may be configured to obtain an initial burst of images, generate a map indicating subjects in the scene based on the initial burst of images, provide a prompt for a user to move the electronic device to capture at least one additional burst of images, and obtain the input set of images based on the initial burst of images and the at least one additional burst of images.

### CROSS-REFERENCE TO RELATED APPLICATION AND PRIORITY CLAIM

This application claims priority under 35 U.S.C. § 119(e) to U.S. Provisional Patent Application No. 63/677,031 filed on Jul. 30, 2024 and U.S. Provisional Patent Application No. 63/753,791 filed on Feb. 4, 2025, both of which are hereby incorporated by reference in their entirety.

### TECHNICAL FIELD

This disclosure relates generally to image processing devices and processes. More specifically, this disclosure relates to interactive selfie panorama capture and multi-perspective undistorted selfie generation.

### BACKGROUND

“Selfies” are a commonly-used mode of image capture. However, selfie cameras have a limited field of view (FOV) because of the distance to subjects and therefore may not be able encompass all subjects of interest. Furthermore, even within that FOV, certain subjects may be distorted based on their locations with respect to the camera. As a result, multi-subject selfies are generally of poor quality.

### SUMMARY

This disclosure relates to interactive selfie panorama capture and multi-perspective undistorted selfie generation.

In a first embodiment, a method includes entering, using at least one processing device of an electronic device, a selfie-capture mode. The method also includes obtaining, using at least one imaging sensor of the electronic device, an input set of images of a scene. The method further includes generating, using the at least one processing device, a differentiable three-dimensional (3D) model of the scene based on an iterative process using the input set of images. In addition, the method includes projecting, using the at least one processing device, the differentiable 3D model into an image space to generate an estimated burst of selfie images. A non-transitory machine readable medium may include instructions that when executed cause at least one processor of an electronic device to perform the method of the first embodiment.

In a second embodiment, an electronic device includes at least one imaging sensor configured to obtain an input set of images of a scene. The electronic device also includes at least one processing device configured to generate a differentiable 3D model of the scene based on an iterative process using the input set of images and to project the differentiable 3D model into an image space to generate an estimated burst of selfie images.

Any one or any combination of the following features may be used with the first or second embodiment. The input set of images may be obtained by obtaining an initial burst of images; generating a map of the scene based on the initial burst of images, where the map indicates subjects in the scene; providing a prompt for a user to move the electronic device to capture at least one additional burst of images; and obtaining the input set of images based on the initial burst of images and the at least one additional burst of images. The differentiable 3D model may be generated by determining a differentiable loss between measured and estimated burst images and updating parameters of the differentiable 3D model to reduce the differentiable loss. The differentiable 3D model may be generated further by generating a depth map based on an estimated depth for each image of the estimated burst of selfie images and initializing the differentiable 3D model with the depth map from each image of the estimated burst of selfie images. Pixels for each image of the estimated burst of selfie images may be classified into semantic classes, and the parameters of the differentiable 3D model may be updated to reduce the differentiable loss by increasing weighting factors of some semantic classes compared to other semantic classes for each image of the estimated burst of selfie images. Perspective information for each image of the estimated burst of selfie images may be obtained, and a rendering for each image of the estimated burst of selfie images may be performed based on the perspective information. A machine learning model may be trained to predict the rendering for each image based on the perspective information prior to performing the rendering. A metric may be generated for each image of the estimated burst of selfie images, and a final image may be obtained based on a comparison of the metrics. A prompt may be provided for a user to select a desired final image from the rendering for each image based on the perspective information. A machine learning model may be trained to predict a differential 3D model of the scene that is optimized further at inference time to produce renderings at different perspectives.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “function,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings:

FIG. 1 illustrates an example network configuration including an electronic device in accordance with this disclosure;

FIG. 2 illustrates an example interactive selfie capture process in accordance with this disclosure;

FIG. 3 illustrates an example interactive selfie capture interface in accordance with this disclosure;

FIG. 4 illustrates an example single-sweep interactive selfie capture process in accordance with this disclosure;

FIG. 5 illustrates an example iterative optimization process in which a differentiable model of a scene is created in accordance with this disclosure;

FIG. 6 illustrates another example iterative optimization process in which a differentiable model of a scene is created in accordance with this disclosure;

FIG. 7 illustrates yet another example iterative optimization process in which a differentiable model of a scene is created in accordance with this disclosure;

FIG. 8 illustrates an example process of training a machine learning model that can be used to predict alternate captures taken from alternate perspectives from a set of burst selfies in accordance with this disclosure;

FIG. 9 illustrates an example process where a user is given options of perspectives to choose from that would reduce distortion of subjects in a scene in accordance with this disclosure;

FIG. 10 illustrates another example process where a user is given options of perspectives to choose from that would reduce distortion of subjects in a scene in accordance with this disclosure; and

FIG. 11 illustrates an example method for obtaining and processing interactive selfie panoramas and multi-perspective selfies in accordance with this disclosure.

### DETAILED DESCRIPTION

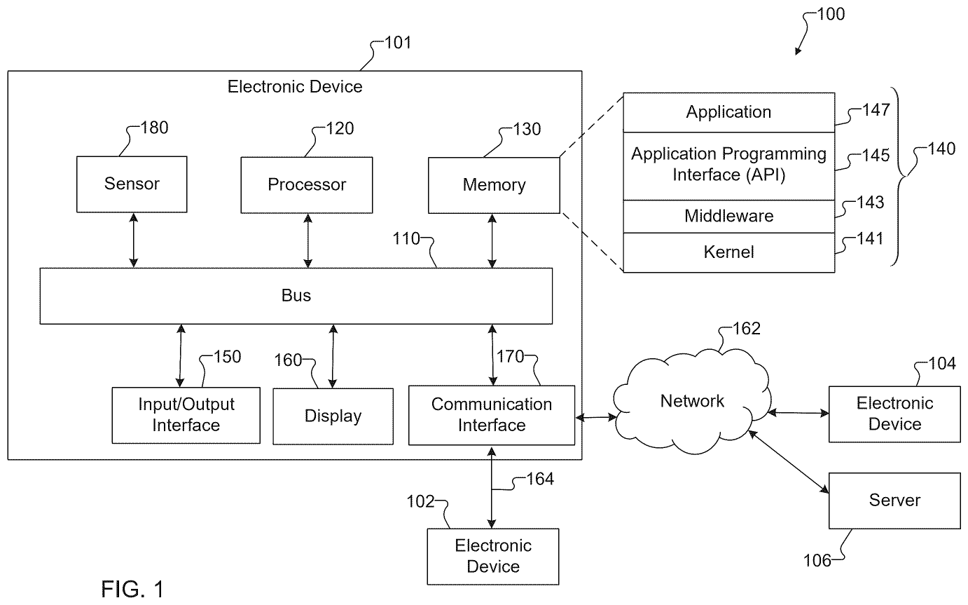

FIGS. 1 through 11, described below, and the various embodiments of this disclosure are described with reference to the accompanying drawings. However, it should be appreciated that this disclosure is not limited to these embodiments and all changes and/or equivalents or replacements thereto also belong to the scope of this disclosure.

As noted above, “selfies” are a commonly-used mode of image capture. However, selfie cameras have a limited field of view (FOV) because of the distance to subjects and therefore may not be able encompass all subjects of interest. Furthermore, even within that FOV, certain subjects may be distorted based on their locations with respect to the camera. As a result, multi-subject selfies are generally of poor quality.

This disclosure describes various techniques for interactive selfie panorama capture and multi-perspective undistorted selfie generation. In some embodiments, a user is prompted to move an electronic device to encompass all subjects to be included in a selfie image. Based on captured images, a map of the subjects may be displayed to the user. Based on this map, the user may be prompted to move the camera around different areas of the map so that undistorted images of all subjects in the scene can be obtained for subsequent processing.

FIG. 1 illustrates an example network configuration 100 including an electronic device 101 in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-1680 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may obtain and process interactive selfie panoramas and multi-perspective selfies as described in more detail below.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, obtain and process interactive selfie panoramas and multi-perspective selfies. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first external electronic device 102, a second external electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the one or more sensors 180 include one or more cameras or other imaging sensors, which may be used to capture images of scenes, including under-display cameras. The under-display cameras can be positioned under an LED panel. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the first external electronic device 102 (such as the HMD), the electronic device 101 can communicate with the first external electronic device 102 through the communication interface 170. The electronic device 101 can be directly connected with the first external electronic device 102 to communicate with the first external electronic device 102 without involving with a separate network. The electronic device 101 can also be an augmented reality wearable device, such as eyeglasses, which includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the first and second external electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as first and second external electronic devices 102 and 104 or server 106) to perform at least some functions associated therewith. The other electronic device (such as first and second external electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the second external electronic device 104 or server 106 via the network 162 or 164, the electronic device 101 may be independently operated without a separate communication function according to some embodiments of this disclosure.

The server 106 can include the same or similar components 110-1680 as the electronic device 101 (or a suitable subset thereof). The server 106 can support to drive the electronic device 101 by performing at least one of operations (or functions) implemented on the electronic device 101. For example, the server 106 can include a processing function or processor that may support the processor 120 implemented in the electronic device 101. As described below, the server 106 may obtain and process interactive selfie panoramas and multi-perspective selfies.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

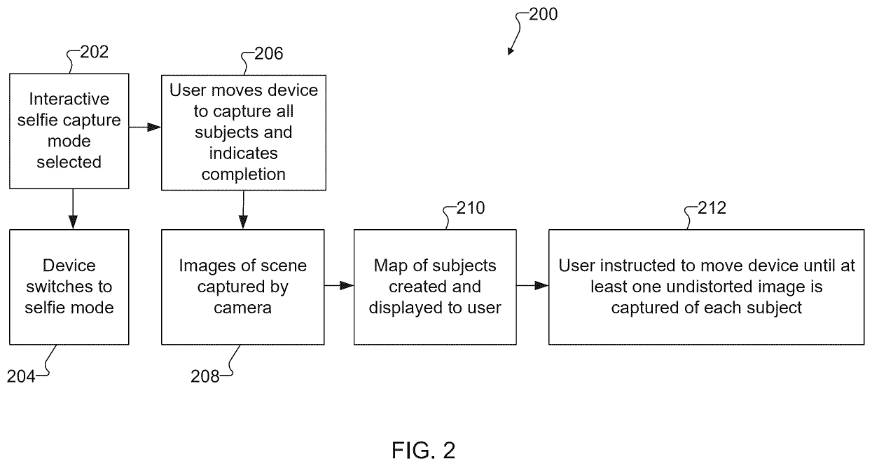

FIG. 2 illustrates an example interactive selfie capture process 200 in accordance with this disclosure. For ease of explanation, the interactive selfie capture process 200 shown in FIG. 2 is described as being implemented on or supported by the electronic device 101 in the network configuration 100 of FIG. 1. However, the interactive selfie capture process 200 shown in FIG. 2 could be used with any other suitable device(s) and in any other suitable system(s). Also, the embodiment of the example interactive selfie capture process 200 shown in FIG. 2 is for illustration only. Other embodiments of the interactive selfie capture process 200 could be used without departing from the scope of this disclosure.

As shown in FIG. 2, the interactive selfie capture process 200 includes, at step 202, a selfie mode of the electronic device being selected. In some embodiments, the selfie mode can be an interactive selfie mode that is selected by a user of the electronic device 101. Note, however, that the selfie mode may be entered in any other suitable manner, such as automatically based on sensed contents of a scene. In response, at step 204, the electronic device switches to the selfie mode, and at least one camera included in the electronic device is selected to capture a selfie image. For example, the camera may be an imaging sensor, such as a complementary metal-oxide-semiconductor (CMOS) image sensor, charge-coupled device (CCD) image sensor, or other image sensor. In some embodiments, such as in the example shown in FIG. 2, selecting the camera can include switching a camera to an interactive selfie mode.

In step 206, the user is prompted to move the electronic device to encompass all subjects to be included in the selfie image. For example, the user may be prompted to move the electronic device 101 via a graphical user interface, such as a graphical user interface presented on a display 160 of the electronic device 101. In some embodiments, the user may manually indicate completion of this step, such as when the user may indicate completion of this step via a user input to the electronic device 101 (like tapping on the display 160 of the electronic device 101). In other embodiments, completion of this step may be sensed automatically, such as by passage of a specified amount of time or by determining that no new subjects have been sensed in the scene for a threshold amount of time.

In step 208, multiple images are captured by the camera. For example, the camera may capture multiple images in rapid succession. The multiple images can be used to construct a map of the subjects, such as by determining where each subject is in the scene. In step 210, the map of the subjects is displayed to the user. For example, the map may be presented via the graphical user interface, such as when the map is presented on the display 160 of the electronic device 101. Based on the map, in step 212, the user is prompted (such as via the graphical user interface) to move the camera around different areas of the map so that undistorted images of all subjects in the scene can be obtained for later processing. Examples of processing of the images are provided below.

Although FIG. 2 illustrates one example of an interactive selfie capture process 200, various changes may be made to FIG. 2. For example, while shown as a series of steps, various steps in FIG. 2 may overlap, occur in parallel, occur in a different order, or occur any number of times. Also, note that any suitable number of cameras may be used to capture the images here.

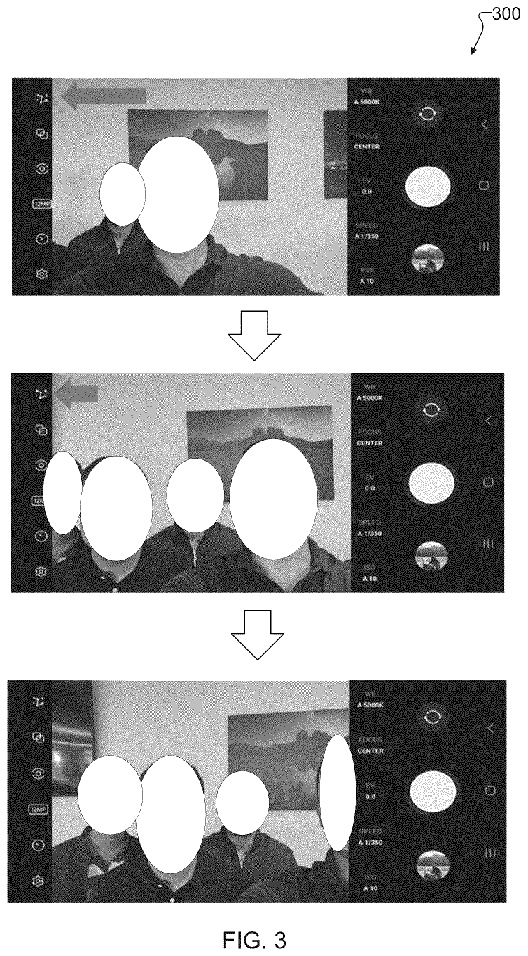

FIG. 3 illustrates an example interactive selfie capture interface 300 in accordance with this disclosure. For ease of explanation, the interactive selfie capture interface 300 shown in FIG. 3 is described as being implemented on or supported by the electronic device 101 in the network configuration 100 of FIG. 1. However, the interactive selfie capture interface 300 shown in FIG. 3 could be used with any other suitable device(s) and in any other suitable system(s). Also, the embodiment of the interactive selfie capture interface 300 shown in FIG. 3 is for illustration only. Other embodiments of the interactive selfie capture interface 300 could be used without departing from the scope of this disclosure.

As shown in FIG. 3, the user is using a camera app or other app on the user's electronic device 101, and a graphical user interface of the app is being displayed. Preview images are being displayed within the graphical user interface, where the preview images represent images of the scene as captured using one or more cameras of the electronic device 101. The user may trigger a selfie mode of the app, which can cause the electronic device 101 to perform the process 200 shown in FIG. 2. Here, the user may be prompted to move the electronic device 101 around different areas of a scene until each person in the scene to be included in a selfie image is identified by the electronic device 101. This allows the electronic device 101 to create a map of the scene. In some cases, outlines (such as elliptical outlines) may be placed around each person's face as identified in the captured images. In this particular example, images of people's faces have been obscured for privacy.

Although FIG. 3 illustrates one example of an interactive selfie capture interface 300, various changes may be made to FIG. 3. For example, the interactive selfie capture interface 300 may have any other suitable form.

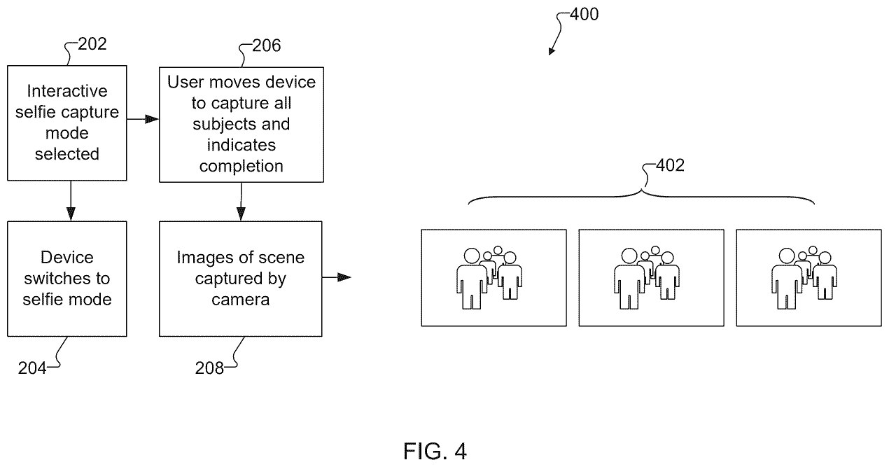

FIG. 4 illustrates an example single-sweep interactive selfie capture process 400 in accordance with this disclosure. For ease of explanation, the single-sweep interactive selfie capture process 400 shown in FIG. 4 is described as being implemented on or supported by the electronic device 101 in the network configuration 100 of FIG. 1. However, the single-sweep interactive selfie capture process 400 shown in FIG. 4 could be used with any other suitable device(s) and in any other suitable system(s). Also, the embodiment of the single-sweep interactive selfie capture process 400 shown in FIG. 4 is for illustration only. Other embodiments of the single-sweep interactive selfie capture process 400 could be used without departing from the scope of this disclosure.

As shown in FIG. 4, the single-sweep interactive selfie capture procedure 400 includes a selfie mode being selected (such as by a user), selecting at least one camera to capture a selfie image, and prompting the user to move the electronic device to encompass all subjects to be included in the selfie image. As a result of the sweep in step 206, a burst 402 of images is captured in step 208, and the burst 402 of images is used for later processing as described below. In comparison to the interactive selfie capture process 200 shown in FIG. 2, the process shown in FIG. 4 is a single-sweep capture that can omit the step of prompting the user to perform further sweeps of the scene. In this particular example, images of people's faces have been obscured for privacy.

Although FIG. 4 illustrates one example of a single-sweep interactive selfie capture process 400, various changes may be made to FIG. 4. For example, while shown as a series of steps, various steps in FIG. 4 may overlap, occur in parallel, occur in a different order, or occur any number of times. Also, note that any suitable number of cameras may be used to capture the images here.

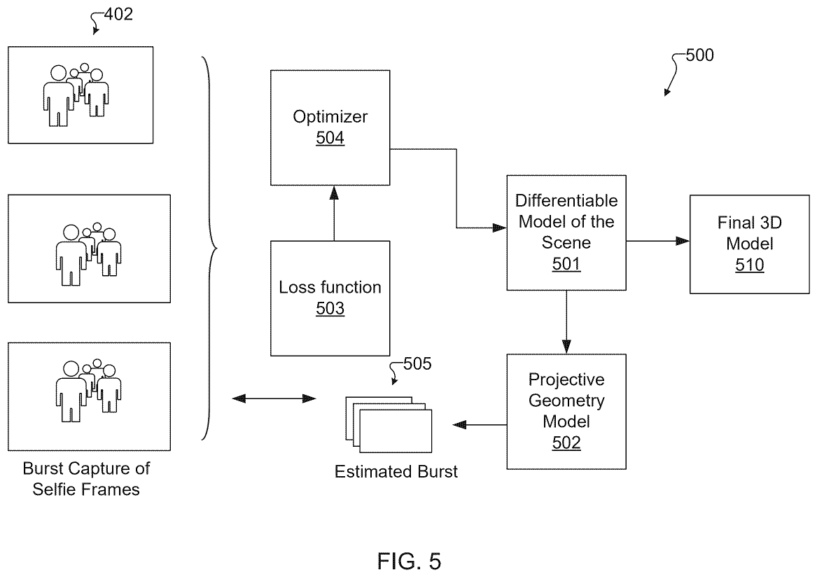

FIG. 5 illustrates an example iterative optimization process 500 in which a differentiable model of a scene is created in accordance with this disclosure. For ease of explanation, the iterative optimization process 500 shown in FIG. 5 is described as being implemented on or supported by the electronic device 101 in the network configuration 100 of FIG. 1, such as during step 210 of the process 200. However, the iterative optimization process 500 shown in FIG. 5 could be used with any other suitable device(s) and in any other suitable system(s). Also, the embodiment of the example iterative optimization process 500 shown in FIG. 5 is for illustration only. Other embodiments of the iterative optimization process 500 could be used without departing from the scope of this disclosure.

As shown in FIG. 5, the iterative optimization process 500 includes the burst 402 of images, which is used to obtain a collection of selfie images. A differentiable model 501 of the scene is created based on the collection of selfie images and provides a representation of the 3D scene that can be differentiated with respect to the underlying parameters of the model. In some embodiments, at the beginning of the iterative optimization, random values are chosen for the parameters of the differentiable model 501. The differentiable model 501 can be represented in various forms. In some embodiments, the differentiable model 501 can be implemented as a specialized artificial intelligence (AI) model.

A projective geometry model 502 projects a 3D model (the differentiable model 501) onto a camera space in order to generate estimated camera images or an estimated burst 505 for the camera positions. The estimated burst 505 is similar to a virtual snapshot or camera capture. In some embodiments, the projective geometry model 502 can perform a projection of images to virtual camera capture positions.

A loss function 503 determines how close an actual burst of captured images is to the estimated burst 505, such as by computing a differentiable loss between the two. In some embodiments, the differential loss can be computed using an L1 norm or structural similarity loss. Various loss functions are known in the art, and other loss functions are sure to be developed in the future. This disclosure is not limited to use with any specific loss functions.

An optimizer 504 uses the loss that is calculated to update the 3D model parameters of the differentiable model 501, where the goal is to adjust the differentiable model 501 to reduce or minimize the calculated loss. If the process is repeated a number of times, a final 3D model 510 that is generated can closely represent the actual 3D scene. Various optimization techniques are known in the art, and other optimization techniques are sure to be developed in the future. This disclosure is not limited to any specific optimization technique.

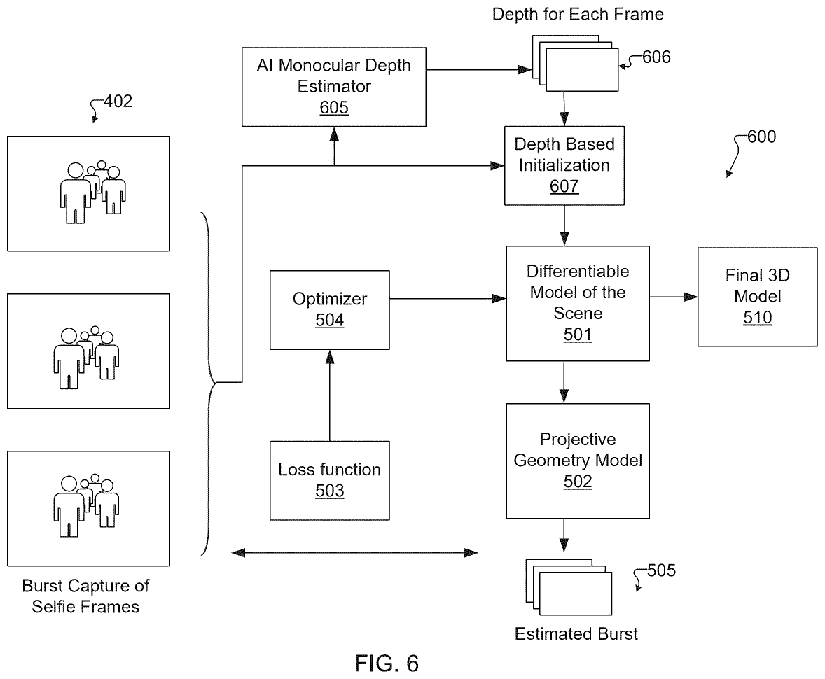

FIG. 6 illustrates another example iterative optimization process 600 in which a differentiable model of a scene is created in accordance with this disclosure. For ease of explanation, the iterative optimization process 600 shown in FIG. 6 is described as being implemented on or supported by the electronic device 101 in the network configuration 100 of FIG. 1, such as during step 210 of the process 200. However, the iterative optimization process 600 shown in FIG. 6 could be used with any other suitable device(s) and in any other suitable system(s). Also, the embodiment of the example iterative optimization process 600 shown in FIG. 6 is for illustration only. Other embodiments of the iterative optimization process 600 could be used without departing from the scope of this disclosure.

The process 600 shown in FIG. 6 is similar to the process 500 shown in FIG. 5. In both instances, a 3D representation of a scene in which subjects of the scene are present and undistorted is created based on the burst 402 of images. In FIG. 6, however, the differentiable model 501 can be initialized using an AI monocular depth estimator 605 and a depth based initialization 607 at the beginning of the iterative optimization.

The AI monocular depth estimator 605 generally operates to estimate depths within each image in the selfie burst to produce a depth map 606 for each image. For example, each depth map 606 may have the same resolution as the corresponding image, and each pixel of a depth map 606 may identify the estimated depth within a scene of an associated pixel in the corresponding image. Various techniques may be used to identify depths, such as by using one or more depth sensors like at least one time-of-flight (ToF) sensor, light detection and ranging (LiDAR) sensor, or stereo vision sensor. In some cases, for example, the depth data may include time measurements of light pulses returning to a ToF sensor, distorted light patterns, or RGB images from slightly different angles.

The depth based initialization 607 generally operates to initialize the differentiable model 501 using the depth maps 606. For example, the depth based initialization 607 may combine the depth maps 606 in order to generate an initial estimate of the 3D structure of the scene being imaged. For a Gaussian splatting-based differentiable model 501, for example, this can be done by generating a point-cloud from the depth maps 606 and initializing Gaussian kernels at the same positions.

In some embodiments, the AI monocular depth estimator 605 can be trained to estimate accurate depths for selfie images. Various depth estimation techniques are known in the art, and other depth estimation techniques are sure to be developed in the future. This disclosure is not limited to any specific depth estimation technique. Similarly, various depth-based initialization techniques are known in the art, and other depth-based initialization techniques are sure to be developed in the future. This disclosure is not limited to any specific depth based initialization technique.

The initial version of the differentiable model 501 may not produce a set of estimated burst images 505 that matches the input burst very well. However, as the optimization progresses and more iterations are performed, the parameters of the differentiable model 501 can converge to values that produce similar burst images to actual bursts under the projective geometry model 502. Accordingly, at convergence, the differentiable model 501 that is produced learns the actual 3D scene captured in the burst images. As a result, burst measurements can be used to update the differentiable model 501 at each step of the iterative process via the loss function 503 and the optimizer 504.

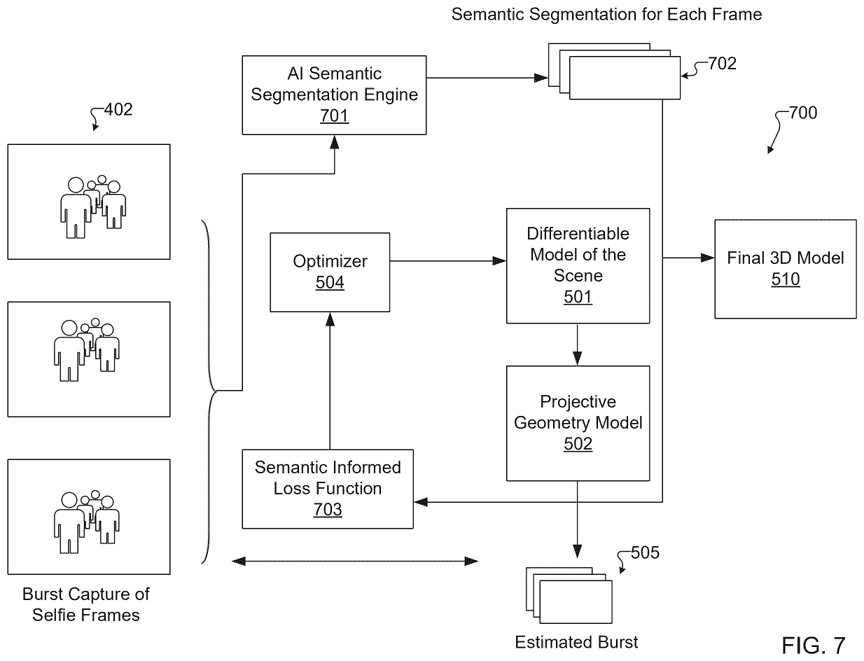

FIG. 7 illustrates yet another example iterative optimization process 700 in which a differentiable model of a scene is created in accordance with this disclosure. For ease of explanation, the iterative optimization process 700 shown in FIG. 7 is described as being implemented on or supported by the electronic device 101 in the network configuration 100 of FIG. 1, such as during step 210 of the process 200. However, the iterative optimization process 700 shown in FIG. 7 could be used with any other suitable device(s) and in any other suitable system(s). Also, the embodiment of the example iterative optimization process 700 shown in FIG. 7 is for illustration only. Other embodiments of the iterative optimization process 700 could be used without departing from the scope of this disclosure.

The process 700 shown in FIG. 7 is similar to the process 500 shown in FIG. 5. In both instances, a 3D representation of a scene in which subjects of the scene are present and undistorted is created based on the burst 402 of images. In FIG. 7, however, an AI semantic segmentation engine 701 performs semantic segmentation for each image in the burst. Semantic segmentation generally involves identifying one of multiple classes of image data represented by each pixel of an image. For example, semantic segmentation may involve determining whether each pixel of an image represents part of a person, foliage (such as trees or bushes), the sky, specific types of objects (such as buildings or vehicles), or other classes of image data. In some embodiments, the AI semantic segmentation engine 701 can classify each pixel into a semantic class chosen from a predefined set of semantic classes to produce a semantic segmentation 702 for each image.

Each semantic segmentation 702 can be applied to a semantic-informed loss function 703 that compares the input burst of images and the estimated burst 505 and determines a differentiable loss between them. Again, in some cases, this can be achieved using an L1 norm or structural similarity loss or any other suitable loss functions for images. However, in comparison to the loss function 503 shown in FIG. 5, the semantic-informed loss function 703 in FIG. 7 can also modulate the loss function to increase weights in some regions (such as face regions) compared to other regions of an image (such as background regions). The loss that is calculated can be subsequently used by the optimizer 504 to update the model parameters of the differentiable model 501, where the goal is to adjust the differentiable model 501 to reduce or minimize the calculated loss.

Although FIGS. 5-7 illustrates examples of iterative optimization processes in which a differentiable model of a scene is created, various changes may be made to FIGS. 5-7. For example, various components or functions in each of FIGS. 5-7 may be combined, further subdivided, replicated, omitted, or rearranged and additional components or functions may be added according to particular needs.

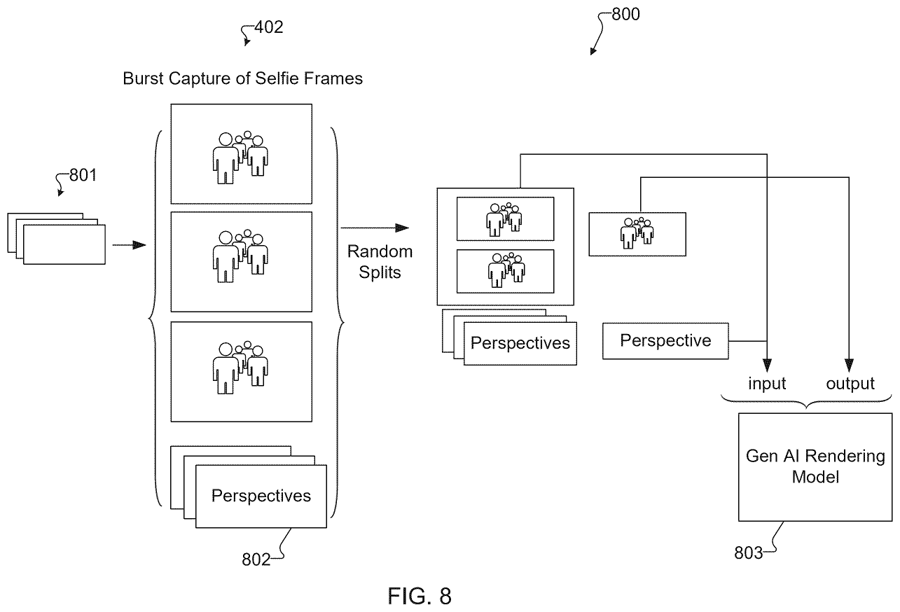

FIG. 8 illustrates an example process 800 of training a machine learning model that can be used to predict alternate captures taken from alternate perspectives from a set of burst selfies in accordance with this disclosure. For ease of explanation, the process 800 shown in FIG. 8 is described as being implemented on or supported by the electronic device 101 in the network configuration 100 of FIG. 1. However, the process 800 shown in FIG. 8 could be used with any other suitable device(s) and in any other suitable system(s). Also, the embodiment of the process 800 shown in FIG. 8 is for illustration only. Other embodiments of the process 800 could be used without departing from the scope of this disclosure.

As shown in FIG. 8, a dataset of burst selfie captures of selfie images 801 for different scenes can be obtained. These selfie images 801 can be obtained from any suitable source(s), such as one or more public or proprietary data sources. In addition to the selfie images 801, the dataset can include perspective information 802 (such as camera position and orientation) recorded for each set of selfie images 801.

For each burst of selfie images 801 for a specific scene, a random image is chosen to be output along with that image's perspective information 802. The rest of the selfie images 801 (along with their corresponding perspective information 802) can be chosen to be input to a machine learning model 803. In some embodiments, the machine learning model 803 can be a generative AI rendering model. The machine learning model 803 can be trained to map the various inputs (representing the rest of the selfie images 801 and their perspective information 802) to a desired output (represented by the selected image and its perspective information 802). In other words, the selected selfie image 801 and its perspective information 802 are used as a ground truth during the training.

This can be repeated any number of times (typically a large number of times over a number of training iterations) in order to train the machine learning model 803. The machine learning model 803 is trained over time during these training iterations to predict the rendering of random perspectives. As a result, the machine learning model 803 can learn to render scenes at arbitrary perspectives given an adequately-large and diverse dataset of selfie images 801.

Although FIG. 8 illustrates one example of a process 800 of training a machine learning model that can be used to predict alternate captures taken from alternate perspectives from a set of burst selfies, various changes may be made to FIG. 8. For example, the machine learning model 803 may be trained in any other suitable manner.

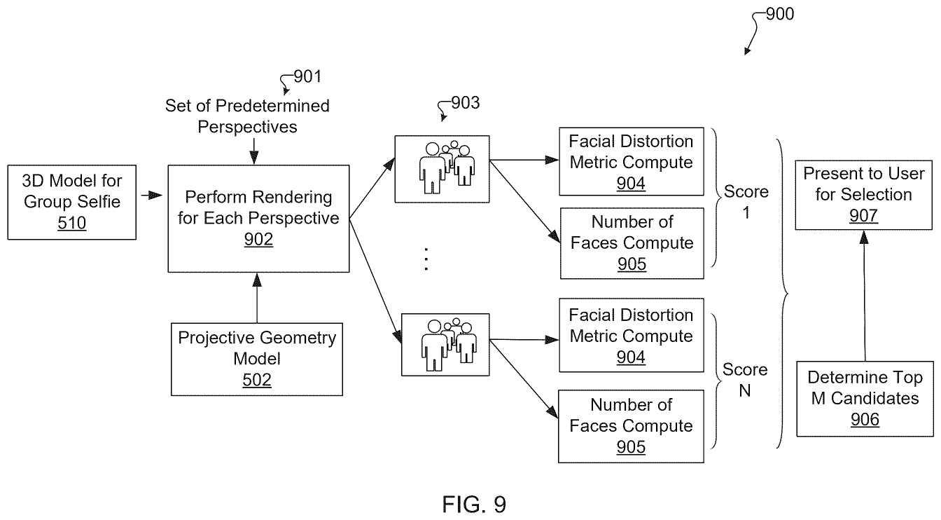

FIG. 9 illustrates an example process 900 where a user is given options of perspectives to choose from that would reduce distortion of subjects in a scene in accordance with this disclosure. For ease of explanation, the process 900 shown in FIG. 9 is described as being implemented on or supported by the electronic device 101 in the network configuration 100 of FIG. 1. However, the process 900 shown in FIG. 9 could be used with any other suitable device(s) and in any other suitable system(s). Also, the embodiment of the process 900 shown in FIG. 9 is for illustration only. Other embodiments of the process 900 could be used without departing from the scope of this disclosure.

As shown in FIG. 9, based on burst-captured selfie images and a 3D representation of the scene, a metric can be obtained, and a user can be presented with options of perspectives to choose from that would reduce distortion of subjects in the scene. Here, the 3D representation of the scene takes the form of the final 3D model 510, which may be produced as described above in relation to FIGS. 5-7.

Using a set of predetermined or other perspectives 901, a rendering 902 for each perspective is performed, which results in the creation of various renderings 903. Here, performing the rendering for each perspective can be done by feeding different perspective inputs to the projective geometry model 502 and projecting the final 3D model 510 to each of the different perspectives.

The generated renderings 903 for the different perspectives can be scored based on one or more metrics. For example, as shown in FIG. 9, the metrics may be a facial distortion metric 904 and a number of faces in an image metric 905. In some embodiments, the facial distortion metric 904 can be determined by fitting ellipses to the segmented shapes of faces and computing residual errors of the fits. Thus, undistorted faces would have lower fitting errors. To make the metric such that a higher value indicates better performance, a negative of the calculated value can be added to an appropriate offset. Another way to compute the facial distortion metric 904 could be to obtain some natural image face data and apply different warpings to it, and a machine learning model can be trained to generate lower metric values for smaller/no warping and larger metric values for large warping. The trained machine learning model can be used to predict a metric for facial distortion. The number of faces in an image metric 905 can be determined using a machine learning-based face segmentation model, face bounding box detector, or other suitable mechanism.

Based on the calculated metrics, a determination 906 of the top candidates can be made, such as by selecting the top M candidate images (where M is a positive integer greater than one). Presentation 907 of the top candidates can be performed, such as by displaying the top M candidate images to the user. The user can be permitted to choose the desired perspective and associated final image.

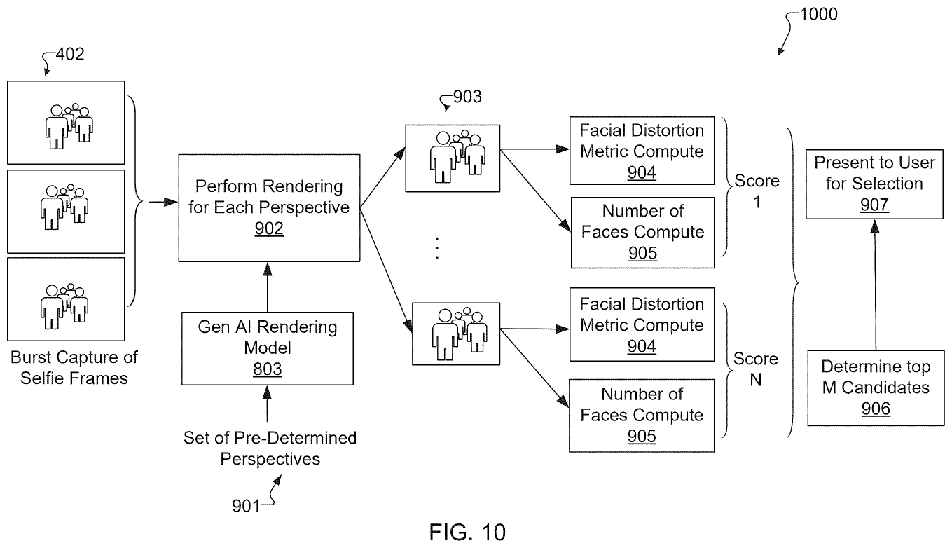

FIG. 10 illustrates another example process 1000 where a user is given options of perspectives to choose from that would reduce distortion of subjects in a scene in accordance with this disclosure. For ease of explanation, the process 1000 shown in FIG. 10 is described as being implemented on or supported by the electronic device 101 in the network configuration 100 of FIG. 1. However, the process 1000 shown in FIG. 10 could be used with any other suitable device(s) and in any other suitable system(s). Also, the embodiment of the process 1000 shown in FIG. 10 is for illustration only. Other embodiments of the process 1000 could be used without departing from the scope of this disclosure.

As shown in FIG. 10, parts of the process 1000 in FIG. 10 can be the same as or similar to the corresponding parts of the process 900 in FIG. 9. However, in FIG. 10, instead of a 3D scene optimization-based technique to compute the rendering of a scene for different perspectives, the trained machine learning model 803 can be used to generate renderings 903 at each perspective. For example, using the set of predetermined or other perspectives 901 and the machine learning model 803, the rendering 902 for each perspective is performed, which results in the creation of various renderings 903. Unlike a scene optimization-based approach, the machine learning model 803 can be made faster. Following this, similar steps as those described above with respect to FIG. 9 can be taken.

Although FIGS. 9-10 illustrate examples of processes where a user is given options of perspectives to choose from that would reduce distortion of subjects in a scene, various changes may be made to FIGS. 9-10. For example, various components or functions in each of FIGS. 9-10 may be combined, further subdivided, replicated, omitted, or rearranged and additional components or functions may be added according to particular needs.

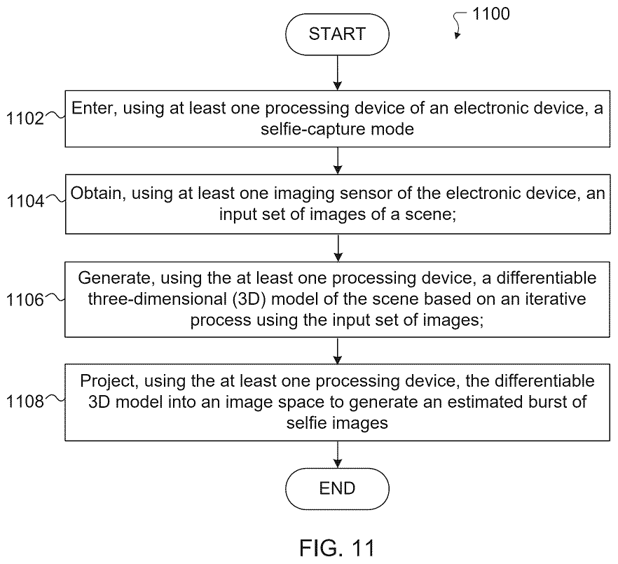

FIG. 11 illustrates an example method 1100 for obtaining and processing interactive selfie panoramas and multi-perspective selfies in accordance with this disclosure. For ease of explanation, the method 1100 shown in FIG. 11 is described as being implemented on or supported by the electronic device 101 in the network configuration 100 of FIG. 1. However, the method 1100 shown in FIG. 11 could be used with any other suitable device(s) and in any other suitable system(s). Also, the embodiment of the method 1100 shown in FIG. 11 is for illustration only. Other embodiments of the method 1100 could be used without departing from the scope of this disclosure.

As shown in FIG. 11, at step 1102, the electronic device 101 can enter a selfie-capture mode, such as based on a user selection. For example, a user may select an interactive selfie capture mode, and the electronic device 101 can switch to a selfie mode. At step 1104, the electronic device can obtain an input set of images of a scene. For example, the user can move the electronic device 101 while one or more cameras of the electronic device 101 capture images of all subjects within the scene. At step 1106, the electronic device can generate a differentiable 3D model of the scene based on an iterative process using the input set of images. For example, a differentiable model 501 or other representation of the 3D scene that can be differentiated with respect to the underlying parameters of the model can be generated.

At step 1108, the electronic device can project the differentiable 3D model into an image space to generate an estimated burst of selfie images. For example, in some embodiments, the electronic device 101 can obtain an initial burst of images and generate a map of the scene based on the initial burst of images, where the map indicates subjects in the scene. The electronic device 101 may optionally provide a prompt for the user to move the electronic device 101 to capture at least one additional burst of images, and the input set of images may be obtained based on the initial burst of images and the at least one additional burst of images. Also, in some embodiments, the electronic device 101 can determine a differentiable loss between measured and estimated burst images and update parameters of the differentiable model 501 to reduce the differentiable loss. For instance, the electronic device 101 may generate a depth map based on an estimated depth for each image of the estimated burst of selfie images and initialize the differentiable model 501 with the depth map from each image of the estimated burst of selfie images. In some cases, to generate the differentiable model 501, the electronic device 101 can classify pixels for each image of the estimated burst of selfie images into semantic classes and update the parameters of the differentiable model 501 to reduce the differentiable loss by increasing weighting factors of some semantic classes compared to other semantic classes for each image of the estimated burst of selfie images.

Once generated, the electronic device 101 can obtain perspective information for each image of the estimated burst of selfie images and generate a rendering 903 for each image of the estimated burst of selfie images based on the perspective information. For example, in some embodiments, the electronic device 101 can train a machine learning model to predict the rendering 903 for each image based on the perspective information prior to performing the rendering.

Although FIG. 11 illustrates one example of a method 1100 for obtaining and processing interactive selfie panoramas and multi-perspective selfies, various changes may be made to FIG. 11. For example, while shown as a series of steps, various steps in FIG. 11 may overlap, occur in parallel, occur in a different order, or occur any number of times.

It should be noted that the functions described above can be implemented in an electronic device 101, 102, 104, server 106, or other device(s) in any suitable manner. For example, in some embodiments, at least some of the functions can be implemented or supported using one or more software applications or other software instructions that are executed by the processor 120 of the electronic device 101, 102, 104, server 106, or other device(s). In other embodiments, at least some of the functions can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
entering, using at least one processing device of an electronic device, a selfie-capture mode;
obtaining, using at least one imaging sensor of the electronic device, an input set of images of a scene;
generating, using the at least one processing device, a differentiable three-dimensional (3D) model of the scene based on an iterative process using the input set of images; and
projecting, using the at least one processing device, the differentiable 3D model into an image space to generate an estimated burst of selfie images.

2. The method of claim 1, wherein obtaining the input set of images comprises:
obtaining an initial burst of images;
generating a map of the scene based on the initial burst of images, wherein the map indicates subjects in the scene;
providing a prompt for a user to move the electronic device to capture at least one additional burst of images; and
obtaining the input set of images based on the initial burst of images and the at least one additional burst of images.

3. The method of claim 1, wherein generating the differentiable 3D model comprises:
determining a differentiable loss between measured and estimated burst images; and
updating parameters of the differentiable 3D model to reduce the differentiable loss.

4. The method of claim 3, wherein generating the differentiable 3D model further comprises:
generating a depth map based on an estimated depth for each image of the estimated burst of selfie images; and
initializing the differentiable 3D model with the depth map from each image of the estimated burst of selfie images.

5. The method of claim 3, further comprising:
classifying pixels for each image of the estimated burst of selfie images into semantic classes; and
updating the parameters of the differentiable 3D model to reduce the differentiable loss by increasing weighting factors of some semantic classes compared to other semantic classes for each image of the estimated burst of selfie images.

6. The method of claim 1, further comprising:
obtaining perspective information for each image of the estimated burst of selfie images; and
performing a rendering for each image of the estimated burst of selfie images based on the perspective information.

7. The method of claim 6, further comprising:
training, using the at least one processing device, a machine learning model to predict the rendering for each image based on the perspective information prior to performing the rendering.

8. The method of claim 7, further comprising:
generating a metric for each image of the estimated burst of selfie images; and
obtaining a final image based on a comparison of the metrics.

9. The method of claim 7, further comprising:
providing a prompt for a user to select a desired final image from the rendering for each image based on the perspective information.

10. The method of claim 6, further comprising:
generating a metric for each image of the estimated burst of selfie images; and
obtaining a final image based on a comparison of the metrics.

11. The method of claim 6, further comprising:
training, using the at least one processing device, a machine learning model to predict a differential 3D model of the scene that is optimized further at inference time to produce renderings at different perspectives.

12. The method of claim 11, further comprising:
generating a metric for each image of the estimated burst of selfie images; and
obtaining a final image based on a comparison of the metrics.

13. The method of claim 11, further comprising:
providing a prompt for a user to select a desired final image from the rendering for each image based on the perspective information.

14. An electronic device comprising:
at least one imaging sensor configured to obtain an input set of images of a scene; and
at least one processing device configured to:
generate a differentiable three-dimensional (3D) model of the scene based on an iterative process using the input set of images; and
project the differentiable 3D model into an image space to generate an estimated burst of selfie images.

15. The electronic device of claim 14, wherein, to obtain the input set of images, the at least one processing device is configured to:
obtain an initial burst of images;
generate a map of the scene based on the initial burst of images, wherein the map indicates subjects in the scene;
provide a prompt for a user to move the electronic device to capture at least one additional burst of images; and
obtain the input set of images based on the initial burst of images and the at least one additional burst of images.

16. The electronic device of claim 14, wherein, to generate the differentiable 3D model, the at least one processing device is configured to:
determine a differentiable loss between measured and estimated burst images; and
update parameters of the differentiable 3D model to reduce the differentiable loss.

17. The electronic device of claim 16, wherein, to generate the differentiable 3D model, the at least one processing device is further configured to:
generate a depth map based on an estimated depth for each image of the estimated burst of selfie images; and
initialize the differentiable 3D model with the depth map from each image of the estimated burst of selfie images.

18. The electronic device of claim 16, wherein the at least one processing device is further configured to:
classify pixels for each image of the estimated burst of selfie images into semantic classes; and
update the parameters of the differentiable 3D model to reduce the differentiable loss by increasing weighting factors of some semantic classes compared to other semantic classes for each image of the estimated burst of selfie images.

19. The electronic device of claim 14, wherein the at least one processing device is further configured to:
obtain perspective information for each image of the estimated burst of selfie images; and
perform a rendering for each image of the estimated burst of selfie images based on the perspective information.

20. The electronic device of claim 19, wherein the at least one processing device is further configured to train a machine learning model to predict the rendering for each image based on the perspective information prior to performing the rendering.
